(19) United States
(12) Patent Application Publication
(10) Pub. No.: US 2013/0042805 A1
(43) Pub. Date: Feb. 21, 2013

(54) POWDER COATING BOOTH WITH TANGENTIAL EXHAUST DUCT

(71) Applicant: Jeffrey R. Shutic, Wakeman, OH (US)

(72) Inventor: Jeffrey R. Shutic, Wakeman, OH (US)

(73) Assignee: Nordson Corporation, Westlake, OH (US)

(21) Appl. No.: 13/213,163

(22) Filed: Aug. 19, 2011

(51) Int. Cl. B05C 19/04

(52) U.S. Cl. 118/308

(57) ABSTRACT

A powder spray booth includes a floor having a longitudinal opening, preferably centered about a central longitudinal axis of the booth. Below the floor surface is an exhaust duct having a tangential entry. Powder overspray is extracted from the booth through the exhaust duct by passing through the floor opening and into the tangential entry to the exhaust duct. A suction device is used to draw powder entrained air through the exhaust duct. The tangential entry produces a swirling powder flow in the nature of a vortex within the exhaust duct to keep the powder in process and not remaining in the exhaust duct. The exhaust duct may include movable plates that form part of the exhaust duct, and also a baffle arrangement for varying the size of the opening in the floor. The exhaust duct may be, for example, cylindrically shaped. The frame that is used to support the exhaust duct may be modular in design to facilitate designing the length of a spray booth for a particular application.

### SUMMARY OF THE DISCLOSURE

The inventions relate generally to powder coating booths such as may be used with powder coating material application systems and processes. More particularly, the inventions relate to a powder coating material spray booth that includes a cylindrically shaped exhaust duct below the spray booth floor with movable plates extending over the exhaust duct.

### BACKGROUND OF THE DISCLOSURE

Powder coating materials are typically applied to objects or workpieces by spray application apparatus and processes. These spray application apparatus and processes include electrostatic and non-electrostatic processes as are well known. Spray application of powder coating material often is done in a spray booth that is used to contain and recover powder overspray. Powder overspray may be recovered from the booth and either recycled back to the feed center for re-use or otherwise disposed to waste or other uses. One of the more significant aspects of any powder coating system is a powder change operation and the associated system down time and labor involved in such changeovers. For example, when the color of the applied powder needs to be changed, the entire system must be cleaned and purged of the just used color before the next color can be applied. This involves the clean and purge of spray guns, feed hoses and most importantly the spray booth.

### SUMMARY OF THE INVENTION

In accordance with one aspect of the one or more inventions disclosed herein, a powder spray booth is contemplated that makes use of an exhaust duct that is disposed below the surface of a floor of the booth. In one embodiment, the exhaust duct includes a tangential entry for powder falling into the exhaust duct through an opening in the floor surface above. In a more specific embodiment, the exhaust duct may be cylindrical. The exhaust duct may be formed of multiple sections.

In accordance with another aspect of one or more of the inventions herein, a plurality of movable plates extend over a portion of the exhaust duct and define one boundary of the floor opening. In one embodiment, each movable plate is hinged on one side to form a cantilever suspension of the plate over the exhaust duct. When the movable plates are in a raised or open position, an operator has full access to the exhaust duct for cleaning operations.

In accordance with another aspect of one or more of the inventions herein, a door mounting arrangement is provided in which an access door is oversized relative to an access opening in the spray booth, with the door hung on hinges or other supports that are mounted to an outside surface of the spray booth wall structure.

In accordance with another aspect of one or more of the inventions herein, a hose stress relief connector is presented for a non-metallic air manifold or plenum.

In accordance with another aspect of one or more of the inventions herein, a spray booth includes a floor having an upper surface, side walls extending up from the floor with each side wall including an air plenum at the bottom of the sidewall, each air plenum having an opening in a first wall to an interior volume of the air plenum, a hose fitting extending through the opening and that is supported by two walls of the air plenum, and a ceiling supported by the side walls.

These and other aspects and advantages of the one or more inventions will be readily understood and appreciated from the following detailed description hereinafter and the accompanying drawings.

### BRIEF DESCRIPTION OF THE DRAWINGS

FIG. 1 is a perspective elevation of a powder spray system using several features of one or more of the present inventions;

FIG. 2 is a perspective elevation of the spray booth of FIG. 1 viewed from the entrance end (left side in FIG. 1);

FIG. 3 is an end elevation of a frame and duct structure used with the spray booth of FIG. 1 showing a movable plate in a lowered position;

FIG. 3A is an enlarged view of the circled region A of FIG. 3;

FIG. 3B is an enlarged view of the circled region B of FIG. 3;

FIG. 4 is the end elevation of FIG. 3 showing the movable plate in a raised or open position;

FIG. 5 is a schematic representation of air and powder flow into the exhaust duct;

FIG. 6 is a plan view of the intake slot and an optional baffle arrangement;

FIG. 6A is a cross-section taken along the line 6A-6A in FIG. 6;

FIGS. 7 and 8 are simplified perspectives of a frame and movable plate arrangement showing the plates in their lowered and raised positions respectively; and

FIG. 9 is an embodiment of an air hose support structure, in longitudinal cross-section.

### DETAILED DESCRIPTION OF THE EXEMPLARY EMBODIMENTS

Although the various embodiments herein illustrate a particular form and structure of a spray booth for applying powder coating material to workpieces, the various inventions may be used alone or collectively in a spray booth having many different designs and features. Except as otherwise noted, the size, materials, layout and structural aspects of the spray booth are design options. The present disclosure is directed to a powder recovery duct concept, and additional features that will be described in detail below. The spray booth may be used in any coating material application system with a wide variety of system features including a feed center for supplying powder coating material, spray guns, electronic control systems for the spray booth, spray guns, gun control systems, gun movers, reciprocators, oscillators and so on, overhead conveyor systems, and powder overspray recovery systems. While the exemplary embodiments illustrate use of a cyclone style recovery system, many other powder recovery technologies may alternatively be used. The only common feature would be the ability create a sufficient air flow to draw powder though the duct and out of the spray booth. The inventions also are not limited to any particular spray technology, and may include but not limited to electrostatic, tribo-electric, non-electrostatic, hybrid technologies, as well as automatic and manual application systems.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions--such as alternative materials, structures, configurations, methods, circuits, devices and components, alternatives as to form, fit and function, and so on--may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

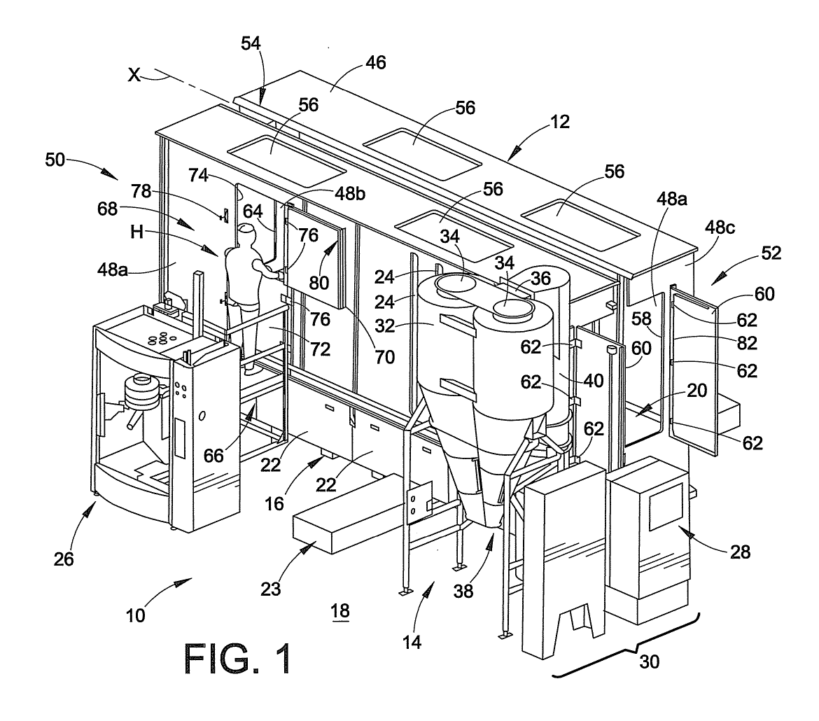

FIG. 1 illustrates a powder coating material application system 10 that includes a spray booth 12 and a powder overspray recovery system 14. The spray booth 12 in this embodiment may be supported on a structural frame 16 above the shop floor 18. For example, the spray booth 12 floor in FIG. 1 may be about two and a half feet or so above the shop floor 18. As will be further described herein, this provides a subfloor space for an exhaust duct that is used to extract overspray powder coating material from the spray booth 12. The raised floor 20 thus also provides space for service bays 22 that may enclose control equipment, air hoses and so on.

Typically, a plurality of powder coating material application devices are used to coat workpieces as they advance through the spray booth interior. These application devices may include automatic and manual spray guns, for example. Automatic guns often are mounted on a gun mover 23 (for simplicity the gun mover structural gun support framework is omitted as this will depend on the type of gun mover used) which may include a reciprocator or oscillator. The gun mover system may be used to both extend and retract the spray guns with respect to the spray booth 12 and also may be used to produce an up/down oscillatory motion of the guns during a spray operation. The application devices may be selected from any number of spray gun designs, including but not limited to a SURE-COAT™ spray gun available from Nordson Corporation, Westlake, Ohio. The spray guns may be electrostatic, noon-electrostatic, tribo-charging or other designs and spraying technology may be used. A series of vertical gun slots or openings 24 may be provided for automatic spray guns.

A feed center 26 may be provided that contains a supply of material that will be applied to objects or work pieces within the spray booth 12. The feed center 26 for example may include any number of hoppers, boxes or other containers of powder, along with suitable pumps and hoses to feed material to the application devices. An example of a feed center is described in U.S. Pat. No. 7,325,750 for POWDER COATING SYSTEM WITH IMPROVED OVERSPRAY COLLECTION, issued Feb. 5, 2008, and also United States published patent application no. US 2008/0017103 A1 for SUPPLY FOR DRY PARTICULATE MATERIAL which was published on Jan. 24, 2008; the entire disclosures of which are fully incorporated herein by reference. However, many different feed centers or other supplies for powder coating material may be used as needed. The U.S. Pat. No. 7,325,750 feed center may, for example, be used with Venturi type pumps for dilute phase systems and the 2008/0017103 feed center may be used, for example, with dense phase pumps for dense phase systems. But the present inventions may be used with dense phase or dilute phase pumps and systems.

A suitable operator interface 28 to a control system 30 may be provided to control operation of the spray guns, the powder recovery system 14, the spray booth 12 including an overhead conveyor (not shown) and the gun mover system. The control system 30 and the operator interface 28 may be selected from any number of well known control system concepts as are well known to those skilled in the art, or specifically designed for a particular system.

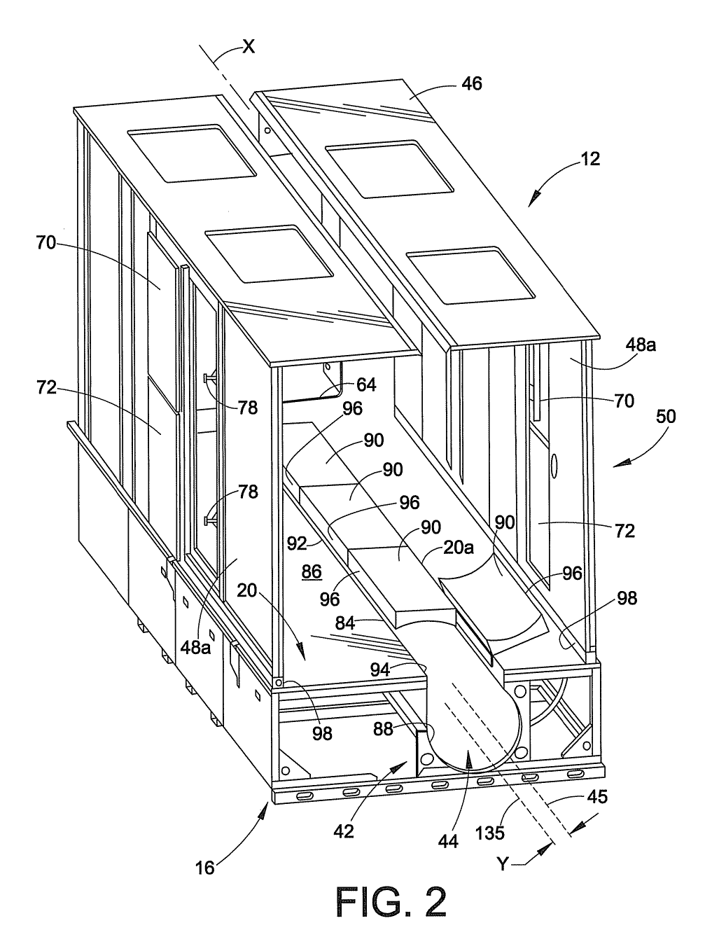

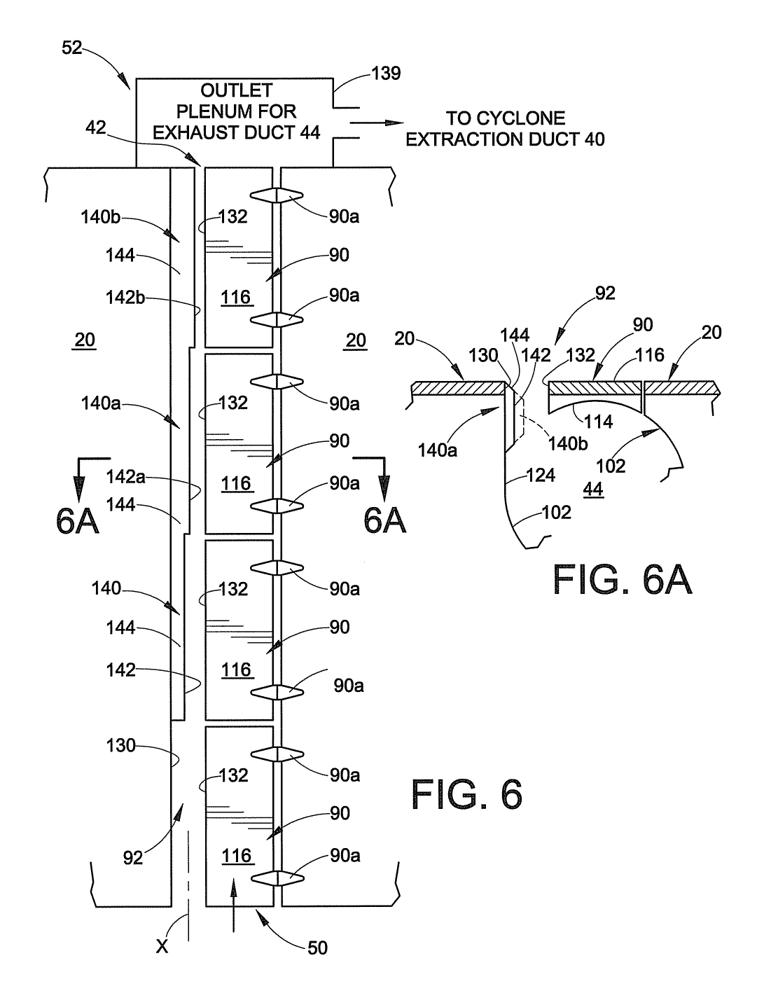

In the exemplary embodiment, the powder overspray recovery system 14 may be realized in the form of a cyclone system 32, however, other recovery system designs may be used. Depending on how much overspray powder needs to be extracted from the spray booth, a single cyclone alternatively may be used. A blower and after filter system (not shown) is in fluid communication with inlets (not shown) of the cyclone and provides the energy required for operation of the cyclone recovery system, in the foim of a substantial powder entrained exhaust air flow pulled from the spray booth interior to an intake duct 36 of the cyclone system 32. The air flow produced by the recovery system also produces a substantial flow of air into and through the spray booth 12, sometimes referred to as containment air. The containment air flow prevents the loss of powder overspray outside the spray booth 12. In the embodiments herein, the cyclone system 32 may be a twin cyclone system, however a single cyclone may alternatively be used. Typically, the after filter system draws a substantial flow or powder entrained air into the cyclones and the separated powder descends to an outlet 38. From the outlet 38 the recovered powder may be returned to the feed center or otherwise dumped to waste or reclaimed in some other manner. The powder entrained air into the cyclone 32 via the intake duct 36 is drawn through a vertical extraction duct 40. Although not shown in FIG. 1, the extraction duct 40 is in fluid communication with an outlet 42 of a horizontal exhaust duct 44 (see FIGS. 2 and 6).

In the exemplary embodiment, powder may either be recovered from the cyclone outlet 38, as is commonly done if the powder will be reused, or alternatively may be extracted from the booth 12 and pass through to the after filter system via a bypass outlet or duct arrangement 34.

The spray booth 12 may be generally rectangular in shape although other shapes and configurations may conveniently be used. A spray booth 12 will typically have a longitudinal axis X. The spray booth 12 may have a ceiling 46 supported by four vertical walls 48. The walls 48 include lateral side walls 48a, a first end wall 48b (illustrated in FIG. 1 through the open manual door 70) at the spray booth entrance end 50, and a second end wall 48c at the spray booth exit end 52. The ceiling 46 may include an overhead conveyor slot 54 that allows hangers to extend from the conveyor to suspend workpieces inside the spray booth 12 interior. The ceiling 46 may also be provided with optional transparent plates 56 for light.

The second end wall 48c includes a large exit opening 58 through which the coated workpieces pass out of the spray booth 12. Part doors 60 are mounted on hinges 62 and may be open during coating operations and closed during booth cleaning operations. The structure for hanging the part doors 60 will be further described with respect to the manual doors hereinbelow.

The first end wall 48b may include a large entrance opening 64 through which the workpieces enter the spray booth 12 interior. Doors typically are not used at the entrance to the spray booth 12 because during cleaning the operator begins at the entrance end and walks through the booth towards the exit end. Also, substantial air flow is desired in order to cause a substantial flow of air into the exhaust duct 44 to draw overspray powder from the spray booth 12 interior.

All of the panels for the spray booth structure, including by not limited to the floor 20, ceiling 46, walls 48 and door panels may each be made of composite materials including a foam core panel and gelcoat inner surface such as sold by Nordson Corporation as an Apogee® panel structure. Other materials may alternatively be used as required, for example, PVC walls and panels. The Apogee® panel constructions are also described in U.S. Pat. No. 6,458,209 for POWDER COATING BOOTH CONTAINMENT STRUCTURE issued to Shutic, Oct. 1, 2002, the entire disclosure of which is fully incorporated herein by reference.

It will also be noted that because the spray booth floor 20 is elevated above the shop floor 18, a scaffolding or other support structure 66 may be used as a stand for an operator H when using a manual spray gun for coating workpieces as they pass through the spray booth 12.

In order for an operator to have access to the spray booth 12 interior for manually spraying workpieces, one or more manual doorways 68 may be provided in the side walls 48a. In this example, each doorway 68 may include a single door or in this example two half doors including an upper door 70 and a separate lower door 72. The separate lower door 72 may be provided when a larger access opening is needed.

An access opening 74 is formed in the side wall 48b. The associated doors 70, 72 are sized so as to have a total perimeter that is at least as great and preferably slightly greater than the perimeter of the access opening 74. In a specific embodiment herein, the doors 70, 72 have a width dimension and a length dimension that are each greater than the corresponding dimensions of the access opening 74. This provides an overlap of the doors 70, 72 with the perimeter of the access openings 74. When the lower door 72 is closed, the upper door 70 has a perimeter that is at least as great and preferably greater than the perimeter of the open section of the access opening 74. Each door 70, 72 is mounted to the exterior surface of the side wall 48a using hinges 76 along one side of the access opening 74. On the opposite side of the access opening 74 a latch 78 may be used to hold the door 70, 72 tightly closed. In order to provide a leak tight seal for powder containment, a seal device 80, such as a flexible D-seal, may be used about the perimeter of the access opening 74 within the overlap region of the associate door 70, 72 to seal the doors 70, 72 when they are closed. Because the doors 70, 72 are slightly oversized relative to the access opening 74, from the inside of the spray booth 12 the door 72, 74 are recessed away from the spray booth interior wall surface but are sealed tight in the closed position.

In a similar manner, the part doors 60 may also be hung on hinges that are affixed to an exterior surface of the second end wall 48c, may be slightly oversized or at least have a perimeter as large as the exit opening 58. A seal device 82 may be disposed on each part door 60 so as to tightly seal the doors 60 when they are closed. Because the part doors 60 tend to be larger than the manual doors 70, 72, a more robust latching mechanism may be used to hold the part doors closed, such as, for example, a swing latch mechanism commonly used on semi-trailer doors.

With reference to FIG. 2, another aspect of one or more of the inventions herein is presented. FIG. 2 is a perspective view from the exit end 52 of the spray booth 12 with the second end wall 48c omitted as well as the end service door that would normally close off the bottom frame 16. This view illustrates how the spray booth 12 is substantially supported on the frame 16 much like a box frame. The floor 20 extends from side to side of the frame 16 and includes a longitudinal opening 84 in the floor surface 86.

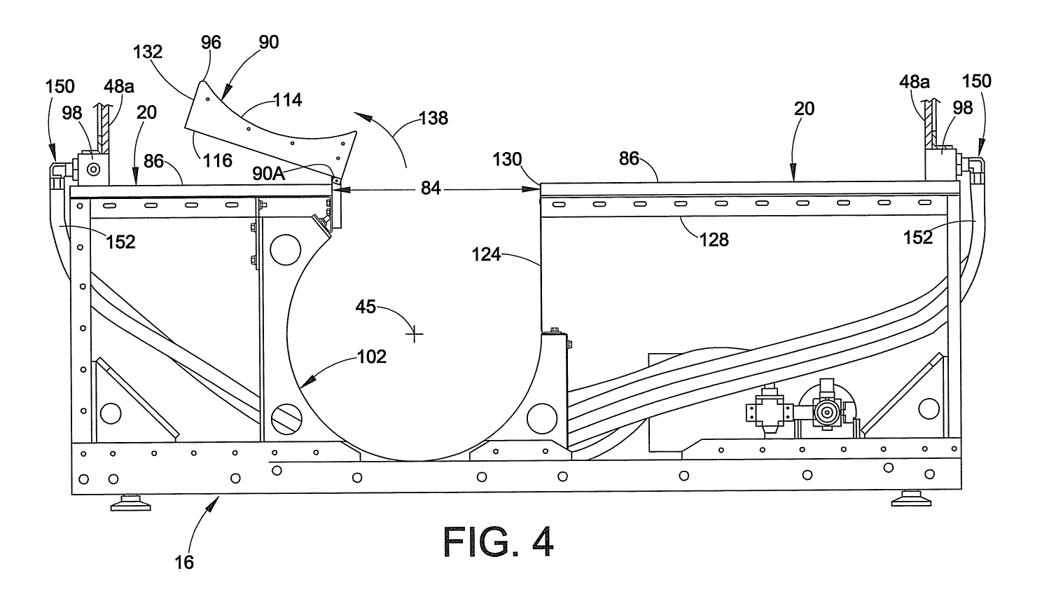

Below the surface 86 of the floor 20 is the exhaust duct 44. The exhaust duct 44 may extend along the entire length of the floor 20 or along at least a part of the length of the floor 20. The exhaust duct 44, as will be described further hereinbelow, may be a multi-piece member 88 or may be one continuous length of duct work. A series of movable panels or plates 90 are hinge mounted to one side of the floor opening 84 (see also FIG. 4) so that in the lowered position of FIG. 2 the movable plates 90 overlay a portion of the duct 44. In FIG. 2, there are four movable plates 90 illustrated with three of the movable plates 90 in the lowered position and one of the movable plates 90 in a raised position. When the movable plates 90 are in the lowered position, they preferably lay flush or coplanar with the floor surface 86 and further preferably can support the weight of an operator without collapsing or bending. Although four movable plates 90 are illustrated, the number is optional and more or fewer, even a single movable plate 90 may be used as required.

The lowered movable plates 90 extend laterally from the hinged lateral side 20a of the floor opening 84 and over the exhaust duct 44, but preferably not all the way to the other lateral side of the floor opening 84. This presents a longitudinal intake gap or slot 92 between an edge 94 of the floor opening 84 and an unhinged edge 96 of each of the movable plates 90. The intake slot 92 (mostly referred to herein as the “slot 92”) to the exhaust duct 44 allows overspray powder that did not adhere to the workpieces during a coating operation to enter into the exhaust duct 44 through the opening 84 in the floor surface 86. The opening 84 in the floor 20 and the intake slot 92 to the exhaust duct 44 may extend along the entire length of the floor 20 or spray booth 12, or may extend along at least a part of the floor 20. The opening 84 and the intake slot 92 need not coextend together the same length or location.

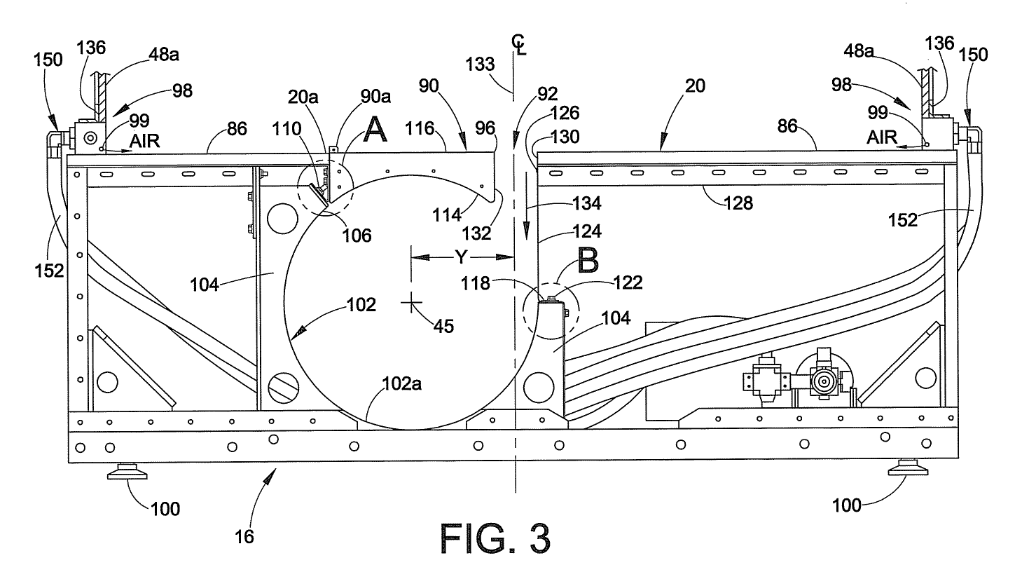

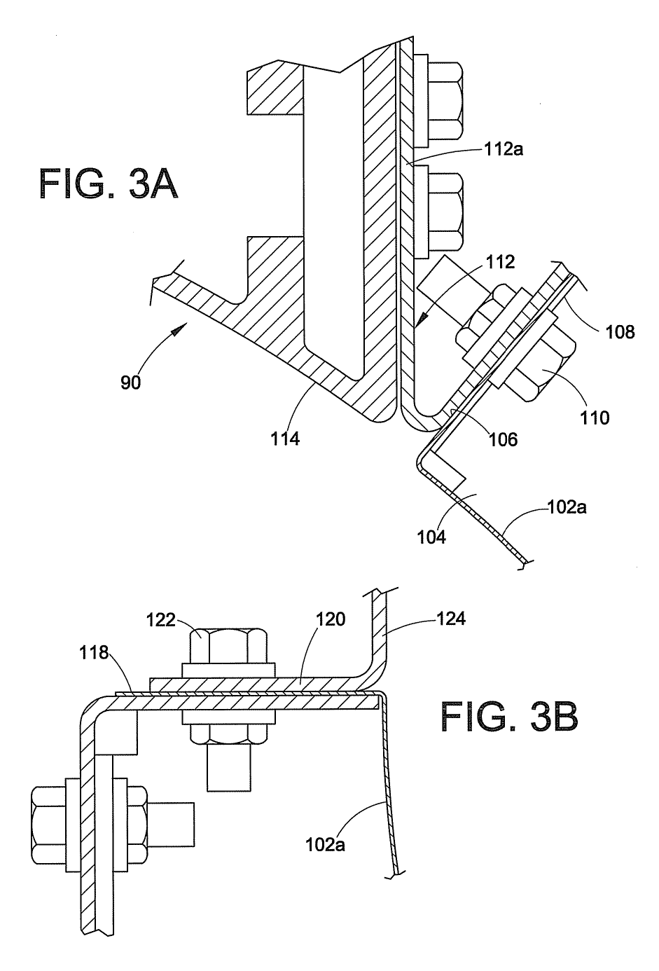

As shown in FIG. 2 as well as FIGS. 3 and 4, the side walls 48a may be supported on top of a respective air plenum or manifold 98, which is mounted to the floor 20. These air plenums include holes or jets (99 in FIG. 3) that are axially spaced lengthwise along the air plenum inside wall that faces the spray booth 12 interior so as to direct pressurized air across the floor surface 86 to blow powder overspray towards the slot 92 during a coating operation.

With reference next to FIGS. 3 and 4, the frame 16 may be a simple box frame made of aluminum extrusions. Leveling legs 100 may be provided in order to adjust the spray booth 10 to be level when installed on the shop floor 18.

The exhaust duct 44 in this example may be formed into a cylindrical shape with a multi-piece design. A first arcuate portion or section 102 of the exhaust duct 44 may be foimed using a flat sheet of metal 102a, for example a 20 gauge sheet of stainless steel. This material is somewhat bendable so that it can be installed into the frame 16 in the form of a partial cylindrical shape. The first arcuate portion 102 may be supported by flanges 104 in order to achieve the arcuate shape. The first arcuate portion 102 may extend the entire length of the exhaust duct 44 or may include end to end aligned shorter lengths. As shown in FIG. 3A, a first longitudinal edge 106 of the first arcuate portion 104 is bent over and affixed to an angled surface 108 of the flange 104. The first longitudinal edge 106 may be attached to the angled surface 108 by any suitable means including bolts 110. The angled surface 108 also may be used to support a V-shaped or acute angle 112 having a vertical mounting plate 112a that is used to support the movable plates 90. The acute angle 112 also has a second plate 112b that is bolted to the angled surface 108 using the bolt 110, with the first longitudinal edge 106 clamped therebetween. It will be noted that the movable plate 90 has an arcuate concave interior surface 114 that forms a second arcuate portion of the exhaust duct 44 and blends with the concave arcuate surface of the first arcuate section 102 when the movable plate 90 is in its lowered position as in FIG. 3. Note also from FIG. 3 how the upper surface 116 of the movable plate 90 preferably aligns coplanar with the floor surface 86 to which the movable plate 90 is hinged when the movable plate 90 is in the lowered position. The upper surface 116 of the movable plate 90 preferably is provided by an Apogee® panel or other surface to match the surface 86 of the floor 20.

The first longitudinal edge 106 may be further affixed to additional flanges 104 along the longitudinal length of the frame 16 as needed.

With reference to FIG. 3B, a second longitudinal edge 118 of the first arcuate portion 102 is affixed to a horizontal surface 120 of the flange 104 with a bolt 122. Also mounted to the flange surface 120 is a vertical inlet sheet or plate 124 that is fixed at its upper edge 126 to the frame leg 128 that supports one side of the floor 20. The inlet sheet 124 runs the length of the exhaust duct 44 and as will be further described may be used to support an optional baffle arrangement.

It can now be noted that the first arcuate portion 102 of the exhaust duct 44 forms part of the cylindrical shape of the exhaust duct 44, in this example about 230 degrees of arc. This portion 102 is easily assembled from a flat sheet of metal 102a and bolted or otherwise affixed to the support frame 16 along each edge of the sheet 102a. This greatly simplifies manufacturing of the exhaust duct 44 as there is no need to preform a cylindrical piece of metal. The sheet 102a used to form the first arcuate potion 102 is somewhat flexible in that it can easily be bent to the desired 230 degree profile, but will also have a natural spring-like potential energy and hoop strength that will help keep the sheet 102a rigid and strong when installed on the frame 16. The second arcuate portion of the exhaust duct 44 is provided by the interior concave surface 114 of the movable plates 90. The arcuate surfaces 102 and 114 preferably have a single common radius so that the exhaust duct 44 is generally circular in shape when viewed end on or in lateral cross-section as in FIGS. 3 and 4. Stated another way, the exhaust duct 44 is provided with a circular profile when viewed in end elevation such as in FIG. 3, although the exhaust duct 44 is not a complete circle in cross-section (nor a complete closed cylinder in three dimensions) because of the tangential entry 134. But in the exemplary embodiment, the perimeter of the exhaust duct 44, formed as it is in several portions including first and second arcuate portions 102 and 114, follows or lies along a circular curve with both arcuate portions 102, 114 having a common diameter. Thus, if the tangential entry 134 were not present and the surface 114 continued along its arc to join the arcuate surface 102, a complete circle in cross-section or cylinder in three dimensions would result.

The vertical inlet plate 124 and an inner edge portion 130 of the floor 20 forms one side of the slot 92 in the floor surface 86 on the unhinged side of the slot 92. The vertical surface of the inner or unhinged cantilever edge 132 of the movable plate 90 forms the other side of the slot 92 when the movable plate 90 is in the lowered position. From FIGS. 3 and 3B it will be noted that the vertical inlet plate 124 aligns preferably or nearly tangentially with the first arcuate portion 102. In this manner the slot 92 aligns on a tangential entry 134 into the exhaust duct 44. The centerline 133 of the tangential entry 134 preferably is perpendicular to and intersects with the longitudinal centerline of the slot 92 and this preferably is also the longitudinal centerline of the spray booth 12 (meaning that the tangential entry 134 and slot 92 are preferably centered in the floor 20). Also from FIG. 3 it will therefore be noted that the longitudinal centerline or axis 45 of the exhaust duct 44 is laterally offset a distance “Y” from the longitudinal centerline 135 (FIG. 2) of the tangential entry 134 which allows the tangential entry 134 to be centered in the spray booth floor 20.

Also from FIG. 3 it will be noted that the side walls 48a are supported on top of the air manifolds or plenums 98 using angles 136. The air plenums 98 include a series of holes or air jets along their length to direct pressurized air (represented by the “Air” arrows in FIG. 3) across the surface 86 of the floor 20 in order to push powder overspray into the exhaust duct 44.

With reference to FIG. 4, one side of each of the movable plates 90 is hinged to the floor 20. FIG. 4 illustrates the movable plate 90 in a raised position. The movable plate 90 is swung open by simply lifting the free edge 132 about the hinge point, as shown by the arrow 138 in FIG. 4. Note that because there is no support for the free or unhinged side of the movable plate 90, the movable plates 90 each have a cantilever suspension over the exhaust duct 44 when in the lowered position (FIG. 3) and form one side boundary of the slot 92 in the floor surface 86. Because of the cantilever design, when the movable plates 90 are in the raised position as in FIG. 4, the operator has complete and unobstructed access to the exhaust duct 44.

It is noted that although there will be small gaps between the adjacent movable plate 90 as well as along the hinged sides of the movable plate 90, the slot 92 defines by far the main inlet or entry and path of least resistance into the exhaust duct 44.

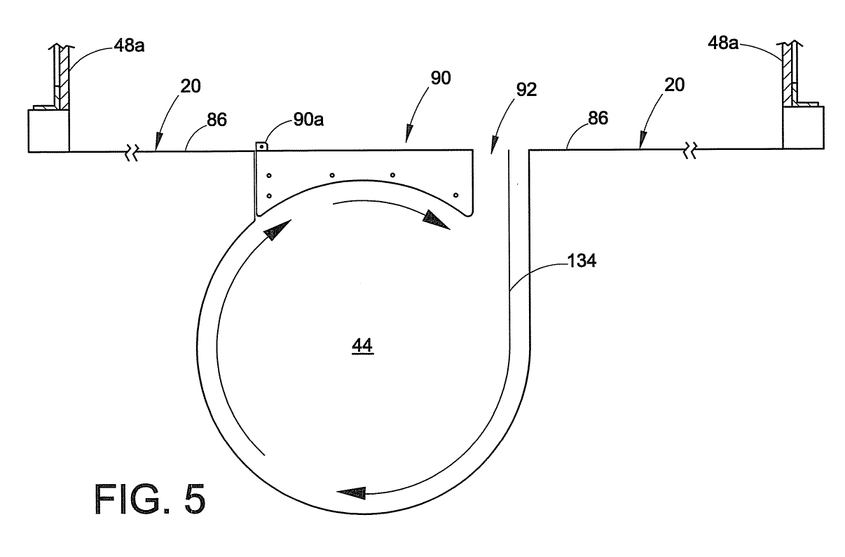

With reference to FIG. 5, the tangential entry 134 into the duct 44 through the opening 92 in the floor 20 causes the powder entrained air mixture to begin flowing in a circular pattern or vortex within the exhaust duct 44 as represented by the directional arrows. This results in part from the fact that the tangential entry concept is used as a single sided tangential entry into the exhaust duct 44. Recalling that the exhaust duct outlet 42 (FIG. 2) is connected to the intake of the powder recover system 14 (FIG. 1) in this example a cyclone system, there is a substantial suction and air flow into the exhaust duct 44 and through the exhaust duct 44 to the recovery system 14. This causes the powder entrained air mixture to swirl within the exhaust duct much in the form of a vortex or helix rather than the typical linear flow pattern in prior exhaust ducts. Moreover, this swirling action tends to concentrate more powder into the helical pattern, somewhat like a rope or stream of powder within the vortex flowing down the exhaust duct 44. This results in a significant improvement in maintaining the powder in process. In other words, the helical or vortical flow pattern within the exhaust duct 44 significantly reduces the amount of powder that can become stranded inside the exhaust duct 44 by maintaining a continuous motion of the powder stream towards the recovery system end of the exhaust duct 44. Thus it can be appreciated that while a cylindrical shape is preferred for the exhaust duct 44, a perfectly circular cross-section is not necessarily required. For example, elliptical, oval or other curved, arced or arcuate surfaces may be used with the tangential entry concept.

FIG. 6 illustrates an embodiment for the spray booth 12 that uses four movable plates 90 overlaying the exhaust duct 44 to form the intake slot 92. As noted, the movable plates 90 are hinged to the floor 20 using any suitable hinge arrangement 90a. All of the movable plates 90 are shown in the lowered position. Along the length of the slot 92, a series of optional baffles 140 may be mounted, preferably removably mounted, on the vertical inlet plate 124 on the side of the slot 90 opposite the cantilever edge 132 of the movable plates 90. The baffles 140 may be used to adjust the width of the slot 92. This may be done, for example, to even out or balance the overall air flow into the exhaust duct 44 and within the spray booth 12 in general, since the suction will be highest near the outlet end of the exhaust duct 44 that is connected through a plenum 139 to the cyclone extraction duct 40 and intake duct 36. Thus it may be desirable to have a wider slot 92 dimension at the far end of the exhaust duct 44, in other words at the entrance end 50 to the spray booth 12, and possibly decrease the slot 92 width as you progress longitudinally along the slot 92 towards the outlet end. The baffles 140 also may be used to adjust the slot 92 width depending on the number and location of the various manual spray guns and automatic spray guns used for a coating operation.

In the example of FIGS. 6 and 6A, each baffle 140 may be realized in the form of a panel 142 having a tapered upper edge 144. The width of the panel 142 will determine how much the width of the slot 92 is reduced. In FIG. 6, no baffle 140 is used opposite the first movable plate 90 nearest the spray booth 12 entrance 50. In addition, three baffles, 140, 140a and 140b are used. These baffles 140, 140a and 140b may but need not get progressively wider so that the slot 92 tapers in width along the longitudinal axis X of the slot 92 towards the exit end 52 of the spray booth 12. This is also represented in FIG. 6A in which the section is taken through the middle baffle 140a and the next baffle 140b is shown in phantom which is closer to the exit end 52 of the spray booth 12. The baffles 140 may include suitable tapers rather than a step-wise progression from baffle to baffle. More or fewer baffles 140 may be used as needed and the width of each baffle will depend on the overall desired air flow into the exhaust duct 44 as well as the number and location of the various powder application devices. The baffles 140 may but need not align with the movable plates 90 as shown in FIG. 6. As an example, the slot 92 may be, for example, about four inches in width and each baffle 140 progressively reducing the slot 92 width by about one inch, so that baffle 140 may be about one inch wide, baffle 140a about two inches wide and baffle 140b about three inches wide. But these are just examples with the useable range for the baffle adjustment to the slot width being whatever is needed to balance the air flow throughout the spray booth 12.

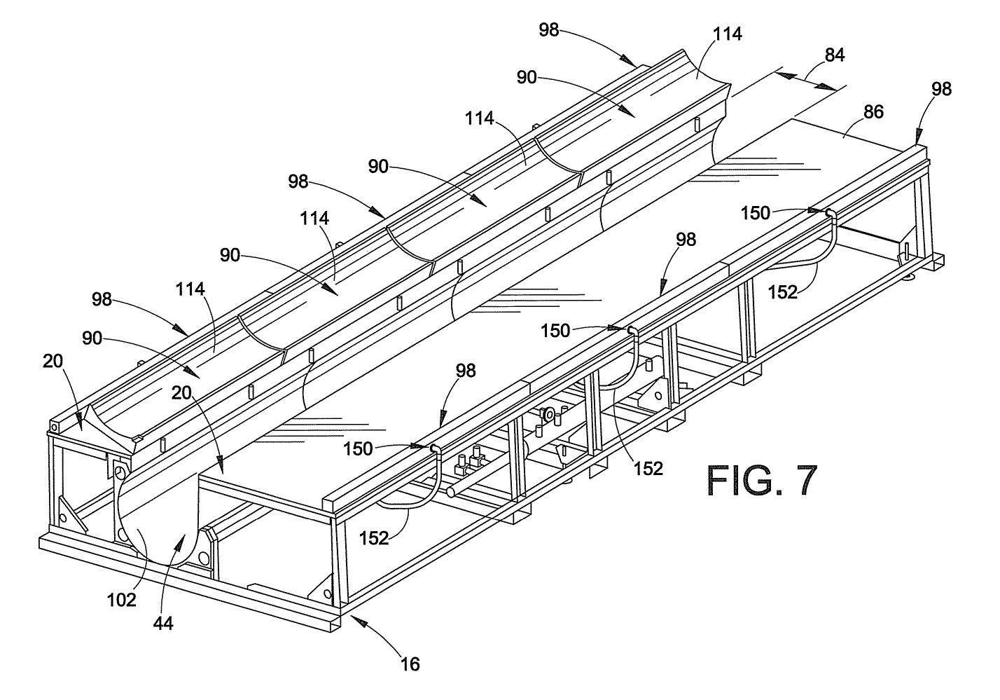

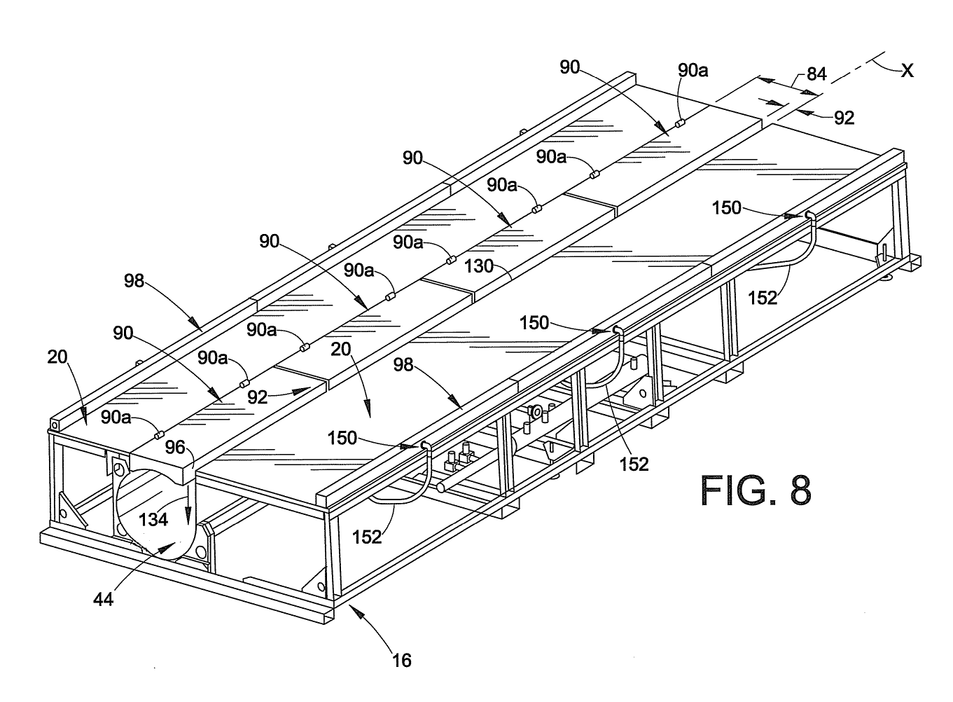

With reference to FIGS. 7 and 8, the frame 16 and floor 20 are shown with the movable plates 90 fully raised as in FIG. 7 and fully lowered in FIG. 8 (the optional baffles 140 are not shown in these views). From FIG. 7 it is apparent that an operator will have full access to the exhaust duct 44 when the movable plates 90 are raised, with no interference from support members on the unhinged side since the movable plate 90 are cantilever suspended over the exhaust duct 44. In practice, typically the movable plates 90 are all in the lowered position during a coating operation. When a cleaning operation or color change operation is to begin, the operator will start by first closing the part doors 60 (FIG. 1), and with the recovery system 14 operating, will start at the entrance end 50 of the spray booth 12. The operator will raise the first movable plate 90 and using an air wand or other suitable device blow off any powder from the exhaust duct 44 or surrounding surfaces as needed, and then progressively advance down the spray booth 12 towards the exit end 52, lifting each movable plate 90 as needed along the way.

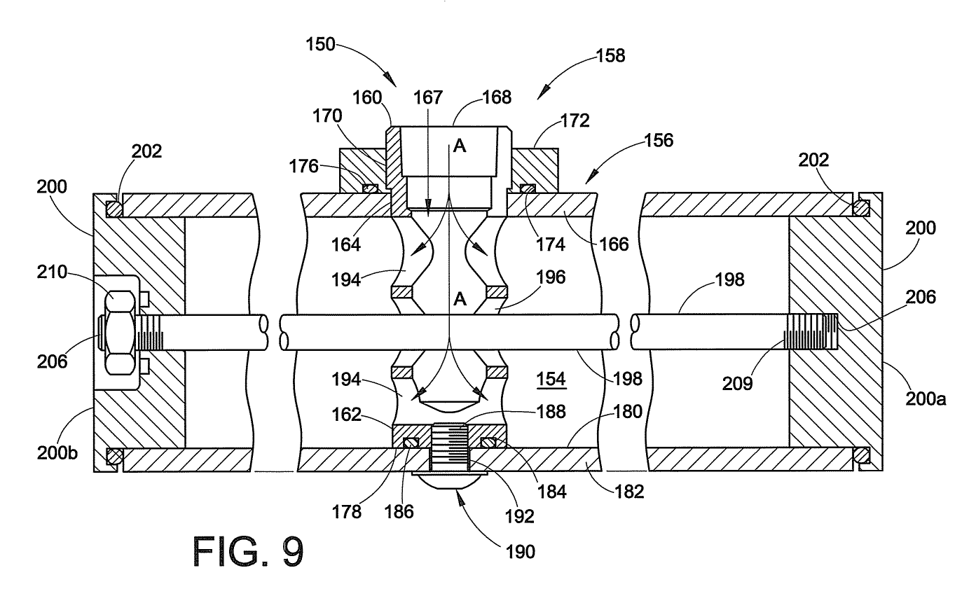

FIGS. 7 and 8 may also be viewed as illustrating one section of the frame 16 that can be combined end to end with additional frame sections in a modular way to extend the length of the spray booth 13. Further note that the air plenum 98 of FIGS. 2 and 3 may be but need not be a continuous single piece plenum, but rather as shown in FIG. 7 one or more of the plenums 98 may be segmented into shorter lengths 98a, 98b and 98c for example. By using shorter segmented lengths, less air volume is needed to blow air through the plenums 98 and out the air jets to blow powder towards the slot 92. Each plenum 98 may include a hose fitting 150 that connects one end of an air hose 152 to an opening in the air plenum 98 (see FIG. 9). The air hoses 152 are periodically provided with pulses of pressurized air that passes into the plenums 98 and out the air jets (not shown) so as to blow powder coating material that did not adhere to the work pieces towards the slot 92. The segmented approach also allows for pulsing different air plenum segments at different times along the length of the spray booth 12, as described in U.S. Pat. No. 6,997,991 issued Feb. 14, 2006 to Keudell et al., for DEVICE FOR CLEANING A POWDER COATING BOOTH AND POWDER COATING BOOTH WITH CLEANING DEVICE, the entire disclosure of which is fully incorporated herein by reference.

With reference to FIG. 9, an embodiment of a hose fitting 150 is shown for providing fluid communication between an air hose 152 (FIG. 7) and an interior volume or air space 154 of an air plenum 156. The air plenum 156, may be, for example, the air plenums 98 described herein. Due to electrostatic and conductive properties of powder coating materials, the spray booth 12, including the air plenums 98, are preferably made of non-conductive plastic or composite type materials, such as the Apogee® panels described hereinabove. Therefore, the air plenums or manifolds 156 are also made of non-conductive materials. In particular, the air plenums 156 may be made of non-metallic materials, or of materials that are low in metallic content such that the air plenums are substantially non-conductive.

One way to connect an air hose to an air plenum would be with a customary bulkhead fitting (not shown) that is threaded onto one of the walls of the air plenum. However, I have found that such non-metal manifolds or plenums may be susceptible to stresses imparted by the air hose to the bulkhead connection when the air hose 152 is pulsed with pressurized air. Typical air pressures for the air plenums 98 may be about 150 psi, for example. This air pressure blast tends to try to force the air hose to straighten and become very rigid, which can result side load on the bulkhead threaded connection. After enough pulses, the non-metallic air manifolds can weaken and become compromised as to being able to support the air hose 152.

The embodiment of FIG. 9 illustrates an air hose fitting 150 concept that allows the hose stresses to be distributed on either side of the air plenum or manifold 156 without the need to rely on threads in the plenum wall. This provides double ended structural support for the hose connector on opposite walls of the air plenum so as to avoid single ended stresses on the air plenum body. Preferably although not necessarily the hose connector 150 is positioned axially about in the middle of the air plenum 156.

In this embodiment, then, the fitting 150 may include a hose connector 158 in the form of a preferably single piece connector body 160 that is unthreaded with respect to a wall 162 of the air plenum 156 through which the connector body 160 passes. The connector body may be realized for example in the form of a spool body 160 (hereafter we refer to the connector body 160 as a spool body) and may include a generally cylindrical wall 162 that slides through a preferably unthreaded opening 164 in a wall 166 of the air plenum 156. The air hose end or proximate end 168 of the hose connector 158 may be adapted as needed to accept one end of an air hose 152 (see FIG. 7). An externally threaded portion 170 of the proximate end 168 may be provided to threadably mate with a nut 172. The nut 172 may be provided with a face seal groove 174 that retains a seal 176 such as, for example, an o-ring.

The spool body 160 extends preferably transversely through the air plenum 156 so that a distal end 178 of the spool body abuts an interior surface 180 of an opposite wall 182 of the air plenum 156. The distal end 178 may also include a face seal groove 184 that retains a seal 186 such as an o-ring, for example. The distal end 178 may also include a threaded bore 188 which can threadably mate with a fastener 190 such as a screw that extends through an opening 192 in the opposite wall 182 of the air plenum. The spool body 160 being generally cylindrical comprises a main air passage 167 for pressurized air (“A”) to enter the air plenum interior volume 154 from an air hose.

Assembly of the hose fitting 150 to the air plenum 156 is easily accomplished by first inserting the spool body 160 into the air plenum 156 through the opening 164 in the first wall 166 until the distal end 178 contacts the opposite wall 182. The screw 190 is then installed and tightened. The second face seal 186 is disposed in the face seal groove 184 before the spool body 160 is inserted into the air plenum 156. Next, the nut 172, with the face seal 176 installed in the face seal groove 174, is tightened onto the proximate and threaded end 168 of the spool body 160. The nut 172 is tightened sufficiently to provide a strong support in tension of the spool body 160, supported at the spool body 160 proximate and distal ends 168, 178. The hose connector 158 is now in fluid communication with the interior volume 154 of the air plenum 156 and is ready for attachment of an air hose. When the nut 172 and the screw 190 are fully tightened, the face seals 176 and 186 are compressed to provide a fluid tight connection between the hose fitting 150 and the air plenum 156.

The spool body 160 may be provided with one or more lateral through bores 194. These through bores 194 act to diffuse pressurized air from the air hose end 168 of the hose connector 158 into the interior volume 154 of the air plenum 156 by allowing the pressurized air to flow axially into the air plenum 156 in both directions (as represented by the arrows A in FIG. 9 in the air passage 167 of the spool body). This avoids a blast of pressurized air being directed at the opposite wall of the air plenum as would typically happen with a conventional single ended bulkhead fitting. The spool body 160 may also include a central bore 196 that also serves as a diffuser and also allows a tie rod 198 to pass therethrough.

FIG. 9 also illustrates one technique for completing the air plenum 156 structure. End members 200 are telescopically inserted at opposite ends of the air plenum 156 with appropriate seals 202 to form an air tight plenum. The tie rod 198 includes a first end 204 that threads into a threaded bore 206 in one of the end members 200, which may be a blind end member 200a. The second end 208 of the tie rod 198 may also be threaded and is adapted to receive a retaining nut 210. The tie rod second end 208 extends to an open end member 200b. When the nut 210 is tightened it is placed in tension and pulls the end members 200 axially towards each other so as to compress the seals 202.

It is intended that the inventions not be limited to the particular embodiments disclosed for carrying out the inventions, but that the inventions will include all embodiments falling within the scope of the appended claims.

1. A spray booth for applying powder coating material by powder spray guns to workpieces in the spray booth, the spray booth comprising:
a floor comprising an upper surface and extending lengthwise along a longitudinal axis of the spray booth,
walls extending up from said floor,
a ceiling supported by said walls,
an exhaust duct disposed below said upper surface of said floor, said exhaust duct comprising a cylindrical wall that extends along at least a part of a length of said floor, said cylindrical wall of said exhaust duct comprising a tangential entry into said exhaust duct at an opening in said upper surface of said floor, said tangential entry of said exhaust duct extending along at least a part of said length of said floor, and
a source of suction connected to said exhaust duct, wherein powder coating material sprayed from the spray guns that does not adhere to the workpieces is drawn from the spray booth above said floor and through said tangential entry into said exhaust duct.

2. The spray booth of claim 1 wherein said cylindrical wall comprises a generally flat sheet of material that is mounted on a frame to conform to an arcuate shape.

3. The spray booth of claim 2 wherein said arcuate shape comprises a single radius.

4. The spray booth of claim 2 wherein said arcuate shape of said cylindrical wall is bolted to said frame.

5. The spray booth of claim 1 wherein said cylindrical wall comprises a first arcuate portion and a second arcuate portion, said first arcuate portion being formed by a fixed wall portion and said second arcuate portion being formed by a movable plate.

6. The spray booth of claim 1 wherein said tangential entry into said exhaust duct comprises a member that has an upper edge aligned with one side of said opening in said upper surface of said floor and a lower edge that aligns tangentially with said first arcuate portion.

7. The spray booth of claim 1 comprising a baffle to adjust the width of said tangential entry along said length of said floor.

8. The spray booth of claim 5 wherein said movable plate comprises a hinged cantilever along one lateral edge and extends over a portion of said exhaust duct.

9. The spray booth of claim 1 wherein said exhaust duct comprises a hinged cantilever member along a lateral edge of said opening in said upper surface and that extends over a portion of said exhaust duct.

10. The spray booth of claim 9 wherein said cantilever member comprises an opposite lateral edge that forms one side of said tangential entry into said exhaust duct when said cantilever member is in a position that overlays a portion of said exhaust duct.

11. The spray booth of claim 1 wherein said exhaust duct is supported on a modular frame with a length of said exhaust duct and said floor being selected based on a number of modular frame sections.

12. The spray booth of claim 1 comprising a pair of side walls with each side wall extending lengthwise along said floor, each said side wall being stacked on top of an air plenum on a respective side of said floor.

13. The spray booth of claim 12 wherein each of said air plenums comprise air holes for directing pressurized air across said floor so as to blow powder overspray from said floor into said exhaust duct through said opening in said upper surface of said floor.

14. The spray booth of claim 1 comprising a source of suction to draw air and powder entrained air into said exhaust duct through said opening in said upper surface of said floor.

15. The spray booth of claim 14 wherein said source of suction comprises an extraction duct connected to a cyclone intake.

16. The spray booth of claim 15 wherein said extraction duct is disposed outside of the spray booth and in fluid communication with a suction end of said exhaust duct.

17. The spray booth of claim 15 wherein powder is sucked through said exhaust duct as a vortex of powder within said exhaust duct.

18. The spray booth of claim 9 comprising a plurality of said hinged cantilever members that extend end to end along said length of said floor.

19. The spray booth of claim 1 wherein said opening in said upper surface of said floor is centered about and extends along a central longitudinal axis of said floor.

20. The spray booth of claim 19 wherein said exhaust duct comprises a longitudinal axis that is laterally offset from said central longitudinal axis of said floor so that said tangential entry aligns with said central longitudinal axis of said floor.

21. The spray booth of claim 6 wherein said first arcuate portion and said second arcuate portion align to form part of said cylindrical wall.

22. The spray booth of claim 5 wherein said movable plate is cantilevered and an unsupported side of said cantilevered movable plate forms one side of said opening in said upper surface of said floor when said movable plate overlays a portion of said exhaust duct.

23. A spray booth for applying powder coating material to an object, the spray booth comprising:
a floor,
a side wall supported on said floor,
said side wall comprising an opening for spraying powder coating material onto an object inside the spray booth,
a hinged door to close said opening, said hinged door having a perimeter that is at least as great as a perimeter of said opening, said door being supported on an outside surface of said side wall.

24. The spray booth of claim 23 wherein said hinged door has a larger width and length that said opening.

25. The spray booth of claim 23 comprising a seal member disposed on said outside surface of said side wall and that seals against said door when said door is in a closed position.

26. A spray booth for applying powder coating material to an object, the spray booth comprising:
a floor comprising an upper surface and extending lengthwise along a longitudinal axis of the spray booth,
a exhaust duct disposed below said upper surface of said floor, said floor comprising an opening along a length of said floor for powder to enter said exhaust duct,
a cantilever member that is hinged to one side of said opening of said floor and overlays a portion of said exhaust duct.

27. The spray booth of claim 26 wherein said exhaust duct comprising a cylindrical wall that extends along a length of said floor, said cylindrical wall of said exhaust duct comprising a tangential entry into said exhaust duct at an opening in said upper surface of said floor, said tangential entry of said exhaust duct extending along said length of said floor.

28. The spray booth of claim 27 wherein said cylindrical wall comprises a generally flat sheet of material that is mounted on a frame to conform to an arcuate shape.

29. The spray booth of claim 28 wherein said arcuate shape comprises a single radius.

30. The spray booth of claim 28 wherein said arcuate shape of said cylindrical wall is bolted to said frame.

31. The spray booth of claim 27 wherein said cylindrical wall comprises a first arcuate portion and a second arcuate portion, said first arcuate portion being formed by a fixed wall portion and said second arcuate portion being formed by a movable plate.

32. The spray booth of claim 27 wherein said tangential entry into said exhaust duct comprises a member that has an upper edge aligned with one side of said opening in said upper surface of said floor and a lower edge that aligns tangentially with said first arcuate portion.

33. The spray booth of claim 27 comprising a baffle to adjust the width of said tangential entry along said length of said floor.

34. The spray booth of claim 31 wherein said movable plate comprises a hinged cantilever along one lateral edge and extends over a portion of said exhaust duct.

35. The spray booth of claim 26 wherein said cantilever member comprises an opposite lateral edge that forms one side of a tangential entry into said exhaust duct when said cantilever member is in a position that overlays a portion of said exhaust duct.

36. The spray booth of claim 26 wherein said exhaust duct is supported on a modular frame with a length of said exhaust duct and said floor being selected based on a number of modular frame sections.

37. The spray booth of claim 26 comprising a pair of side walls with each side wall extending lengthwise along said floor, each said side wall being stacked on top of an air plenum on a respective side of said floor.

38. The spray booth of claim 37 wherein each of said air plenums comprise air holes for directing pressurized air across said floor so as to blow powder overspray from said floor into said exhaust duct through said opening in said upper surface of said floor.

39. The spray booth of claim 26 comprising a source of suction to draw air and powder entrained air into said exhaust duct through said opening in said upper surface of said floor.

40. The spray booth of claim 39 wherein said source of suction comprises an extraction duct connected to a cyclone intake.

41. The spray booth of claim 40 wherein said extraction duct is disposed outside of the spray booth and in fluid communication with a suction end of said exhaust duct.

42. The spray booth of claim 26 wherein powder is sucked through said exhaust duct as a vortex of powder within said exhaust duct.

43. The spray booth of claim 26 comprising a plurality of said hinged cantilever members that extend end to end along said length of said floor.

44. The spray booth of claim 26 wherein said opening in said upper surface of said floor is centered about and extends along a central longitudinal axis of said floor.

45. The spray booth of claim 44 wherein said exhaust duct comprises a longitudinal axis that is laterally offset from said central longitudinal axis of said floor so that a tangential entry to said exhaust duct aligns with said central longitudinal axis of said floor.

46. An air hose fitting for a powder spray booth, comprising:
a non-metallic air plenum, an opening through a first wall of said air plenum to an interior volume of said air plenum, and a connector body that extends through said opening, said connector body comprising a proximate end that is secured to said first wall and a distal end that is secured to a second wall of said air plenum.

47. The air hose fitting of claim 46 wherein said proximate end of said connector body can retain an air hose end, said connector body comprising an air passage into said interior volume of said air plenum.

48. The air hose fitting of claim 47 wherein said connector body comprises a lateral bore so that pressurized air that enters said air passage from an air hose passes into said interior volume of said air plenum in a direction that is generally transverse said air passage.

49. The air hose fitting of claim 46 wherein said connector body is secured to said first wall other than be a threaded connection in said first wall.

50. The air hose fitting of claim 46 wherein said connector body is secured to said second wall other than by a threaded connection in said second wall.

51. A spray booth for applying powder coating material by powder spray guns to workpieces in the spray booth, the spray booth comprising:
a floor comprising an upper surface and extending lengthwise along a longitudinal axis of the spray booth,
side walls extending up from said floor, with each side wall extending lengthwise along said floor, each said side wall including an air plenum at the bottom thereof, an opening through a first wall of said air plenum to an interior volume of said air plenum, an air hose fitting connector body that extends through said opening, said connector body comprising a proximate end that is secured to said first wall and a distal end that is secured to a second wall of said air plenum; and
a ceiling supported by said walls.

52. The powder spray booth of claim 51, wherein each side wall is stacked on top of one of said air plenums.

53. The powder spray booth of claim 51 wherein said booth further includes an exhaust duct and each of said air plenums comprise air holes for directing pressurized air supplied through said air hose fitting across said floor so as to blow powder overspray on said floor into said exhaust duct.

54. The powder spray booth of claim 51 wherein said air plenums are constructed from non-metallic materials.
